(19) United States
(12) Patent Application Publication
(10) Pub. No.: US 2011/0240548 A1
(43) Pub. Date: Oct. 6, 2011

(54) SCREEN JOINT

(75) Inventor: John S. Pionkowski, Mentor, OH (US)

(73) Assignee: W.S. Tyler

(21) Appl. No.: 13/044,040

(22) Filed: Mar. 9, 2011

Related U.S. Application Data
(60) Provisional application No. 61/312,109, filed on Mar. 9, 2010.

(51) Int. Cl. B01D 39/12; B23K 11/00; B01D 29/50; B01D 29/11

(52) U.S. Cl. 210/323.2; 219/117.1

(57) ABSTRACT

A screen joint assembly includes a joint comprising a ring portion and a lip portion protruding from the ring. A first particle screen is connected to a first side of the joint and a second particle screen connected to a second side of the joint. The lip portion may be welded to form a weld seam that interconnects the first and second particle screens.

### CROSS REFERENCE TO RELATED APPLICATION

This application claims the benefit of U.S. Provisional Patent Application No. 61/312,109, titled “SCREEN JOINT,” filed Mar. 9, 2010, which is hereby incorporated in its entirety.

### BACKGROUND

The present invention relates to a joint for particle control filtration screens, particularly for use in a well.

Liquids and gases in water, oil and gas wells typically mix with particulates that need to be filtered away from the production fluid. These particulates include sand, clay, and other unconsolidated particulate matter. The presence of sand and other fine particles in the production fluid and well equipment often leads to the rapid erosion of expensive well machinery and hardware.

Particle screens, also known as downhole screens, sand screens or well screens, have been used in the petroleum industry to remove particulates from production fluids. Commonly, particle screens are used in conjunction with a filter aid that does primary filtering, whereas the particle screen retains the filter aid but allows throughput of the liquid or gas. Particle screens are generally tubular in shape and include a perforated base pipe, a porous filter layer wrapped around and secured to the pipe, and an outer cover. Particle screens are used where fluid enters a production string, such that the fluid must pass through the filter layer and into the perforated pipe prior to entering the production string and being pumped to the surface.

In the context of downhole filtration, particle screens often include woven wire mesh to prevent particles of the desired size and larger from passing through the mesh. The screen acts to trap the particles on the top surface of the mesh. Wire wrap is also commonly used in surface filtration. Wire wrap may be triangular shaped wire wrapped around a base pipe, with a given gap between wires designed to accomplish a desired micron rating.

Particle screens are often constructed in modular sections, such as four foot sections. The screen sections are fixed together inside the pipe by way of a joint. Due to pressures and stresses that exists within the pipe, it is desirable that the joint be capable of tolerating designated burst and collapse pressures. Known screen joints include basic weld joints and other [insert other possible joints]. While these joints are capable of connecting screen sections, they often fail to tolerate the desired burst and collapse stresses within the pipe. Further, known joints often fail to support the shape of the particle screen to help prevent warping and other defects. Therefore, an improved screen joint is needed.

### SUMMARY

A screen joint assembly is generally described. The screen joint assembly includes a joint comprising a ring portion and a lip portion protruding from the ring. A first particle screen is connected to a first side of the joint and a second particle screen connected to a second side of the joint. The lip portion may be welded to form a weld seam that interconnects the first and second particle screens.

### BRIEF DESCRIPTION OF THE DRAWINGS

Objects and advantages together with the operation of the invention may be better understood by reference to the following detailed description taken in connection with the following illustrations, wherein:

FIG. 1 illustrates a screen joint.

FIG. 2 illustrates a screen joint connected to a particle screen section.

FIG. 3 illustrates a screen joint connected to a first particle screen and aligned with a second particle screen.

FIG. 4 illustrates a side view of a screen joint interconnecting two particle screen portions.

FIG. 5 illustrates a perspective view of a screen joint interconnecting two particle screen portions.

FIG. 6 illustrates a perspective view of a screen joint welded to two particle screen portions.

FIG. 7 illustrates an interior view of a screen joint interconnecting two particle screen portions.

FIG. 8 illustrates a pre-formed screen joint.

FIG. 9 illustrates a screen joint formed from a pre-formed metal ring.

### DETAILED DESCRIPTION OF THE INVENTION

Reference will now be made in detail to embodiments of the invention, examples of which are illustrated in the accompanying drawings. It is to be understood that other embodiments may be utilized and structural and functional changes may be made without departing from the respective scope of the invention.

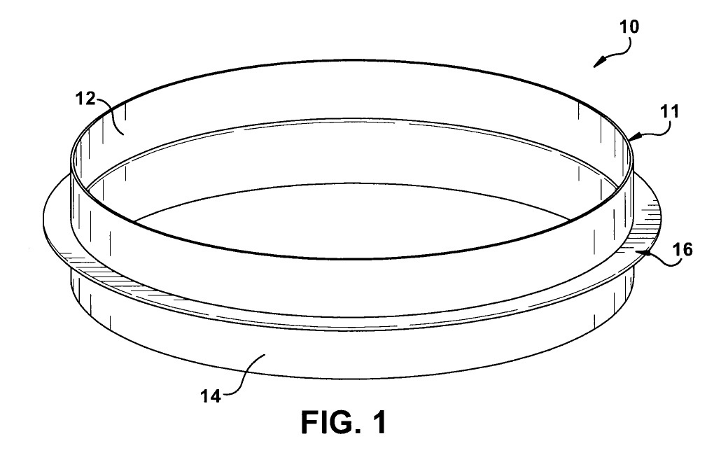

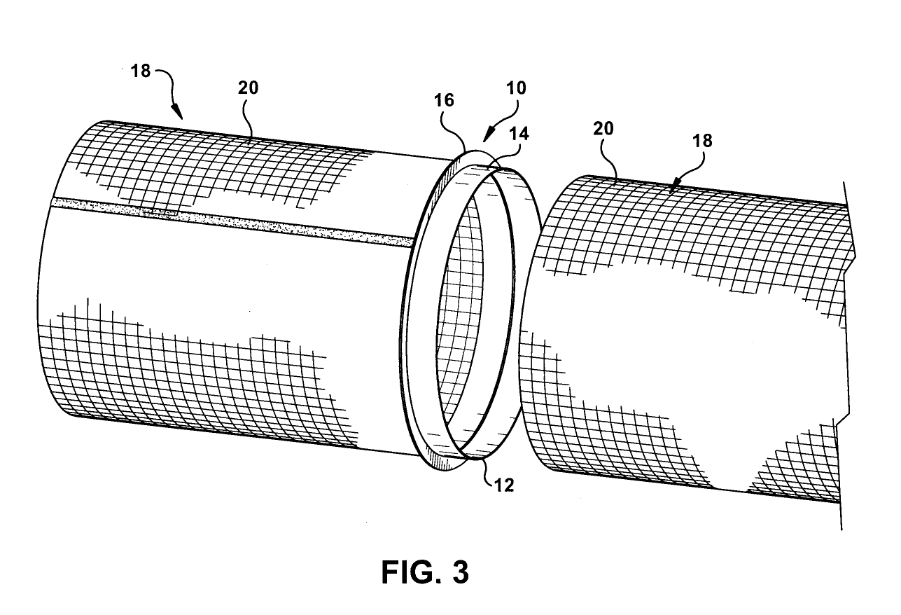

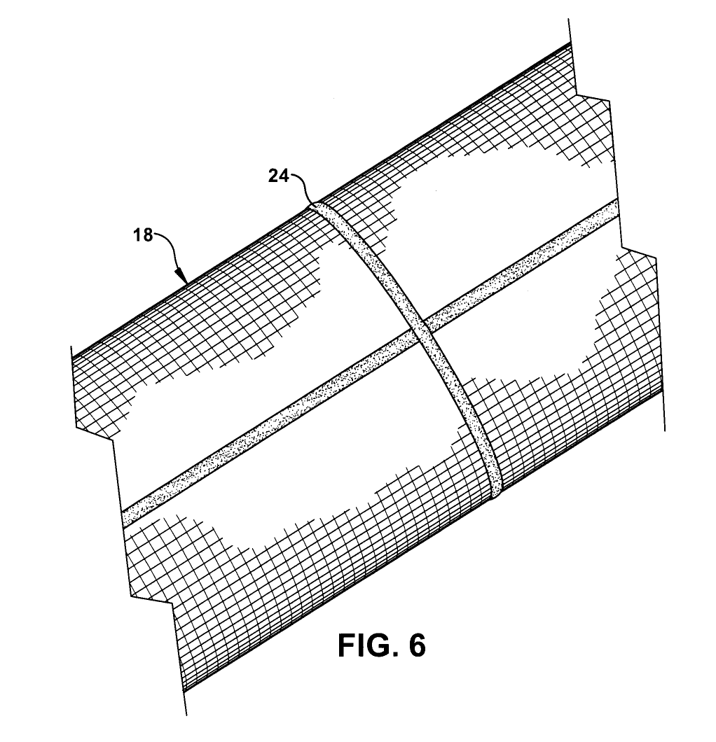

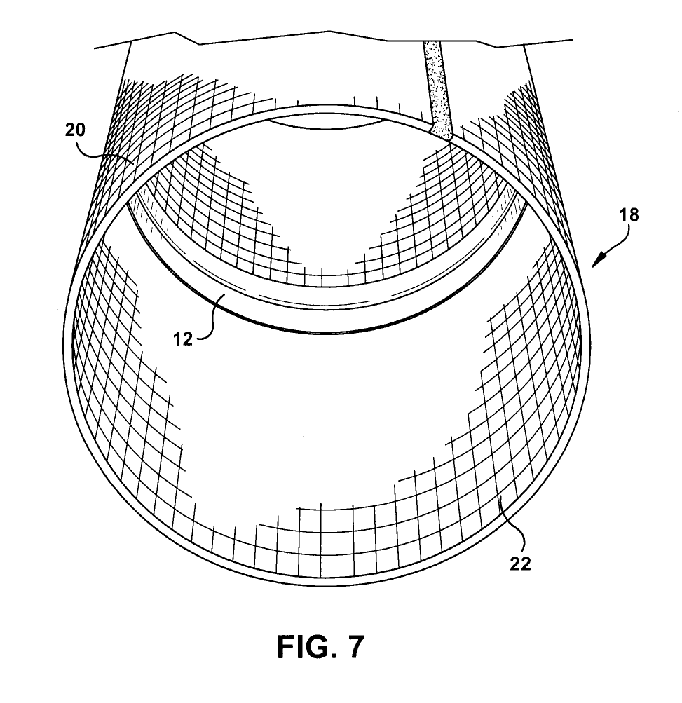

A screen joint 10 is presented, as illustrated in FIGS. 1-9. The screen joint 10 may be composed of any material, such as plastic or metal known in the art. In an embodiment, the screen joint 10 may be composed of a metal, such as steel, that is capable of being welded.

The screen joint 10 is configured to interconnect two or more portions, such as two or more particle screens 18. To that end, the screen joint 10 includes a generally flat ring 11 and a lip 16. The ring 11 includes an inner surface 12 and an outer surface 14. The lip 16 may protrude from the outer surface 14 to provide an adjoining member for a particle screen 18. The lip 16 may be positioned to bisect the ring 11 such that the ring 11 extends generally equidistantly from either side of the lip 16. As shown in FIG. 1, the lip 16 may extend approximately perpendicularly from the outer surface 14. It will be appreciated, however, that the lip 16 may protrude from the outer 14 at any angle to interconnect two screen portions. In an alternatively embodiment, the lip 16 may protrude from the inner surface 12, or may extend through both the inner surface 12 and outer surface 14.

The screen joint 10 may be configured to connect to a similarly shaped screen portion 18 on either side of the lip 16. For example, the screen joint 10 may be generally circular, as shown in FIG. 1, and configured to engage a generally circular opening of a particle screen 18. It will be appreciated, however, that the screen joint 10 may be any shape configured to engage or interconnect particle screen portions 18.

As described herein, a particle screen 18 may comprise any screen adapted to sift and filter particles, such as sand, clay, and other particulate matter, from production fluid to be extracted. The particle screen 18 may be composed of wire mesh or a series of wire mesh layers. It will be appreciated, however, that the particle screen 18 may comprise any material capable of filtering unwanted particulate matter. The particle screen 18 may be generally tubular shaped, such as cylindrical. The tubular particle screen 18 may include an exterior surface 20 and an interior surface 22.

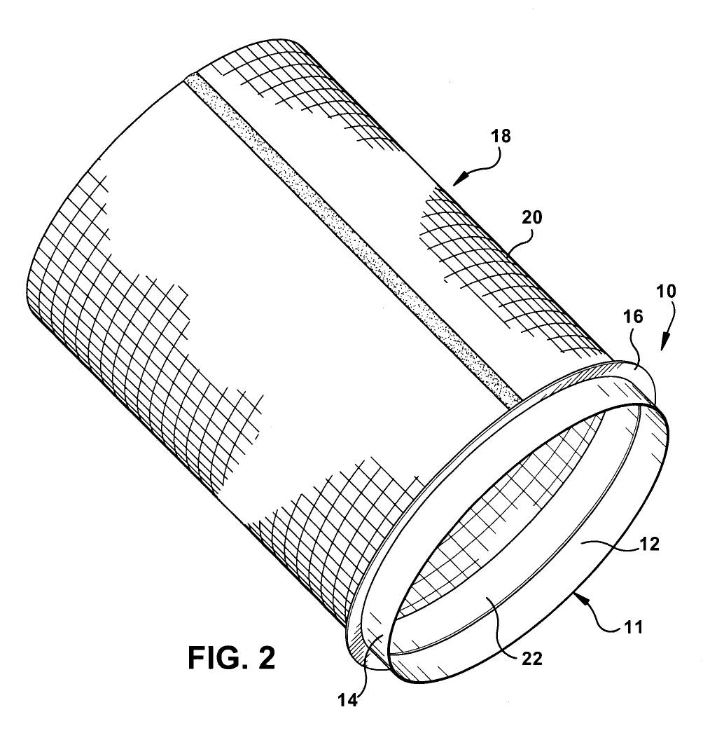

In an embodiment shown in FIGS. 2-7, the outer surface 14 of the screen joint 10 may engage the interior surface 22 of the particle screen 18. The ring 11 may be sized and shaped to provide minimal clearance between the outer surface 14 and the interior surface 22 of the particle screen 18, such that the outer surface 14 frictionally engages the interior surface 22 of the particle screen 18. This arrangement allows the inner surface 12 of the screen joint 10 to form approximately flush with the interior surface 22 and thereby support the shape of the particle screen 18. The screen joint 10 may engage a particle screen 18 on either side of the lip 16 to adjoin two particle screens 18.

The screen joint 10 may be configured to provide the desired amount of support for the particle screen 18 or to regulate flow capacity. For example, the width or thickness of the ring 11 may be increased to provide greater support along the interior surface 22 of the particle screen 18. The engagement between the outer surface 14 and the interior surface 22 of the particle screen 18, however, obstructs the openings in the particle screen 18. Consequently, widening the ring 11 may reduce the flow capacity of the particle screen 18. Thus, the width of the ring 11 may alternatively be reduced to increase the flow capacity of the particle screen 18.

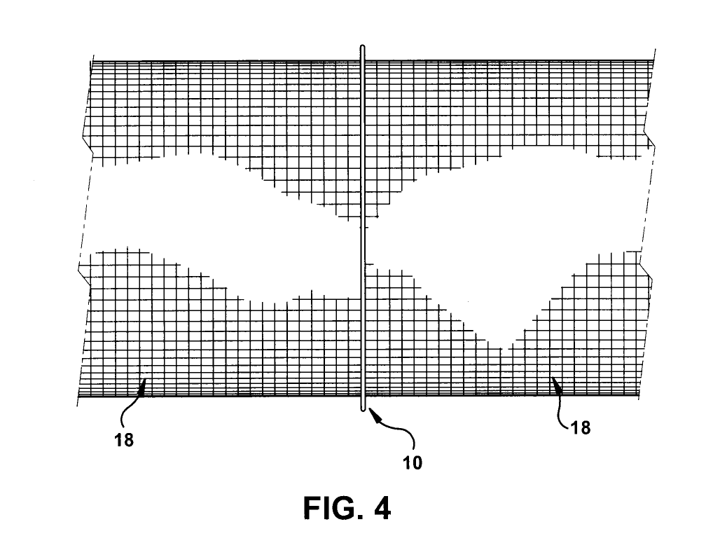

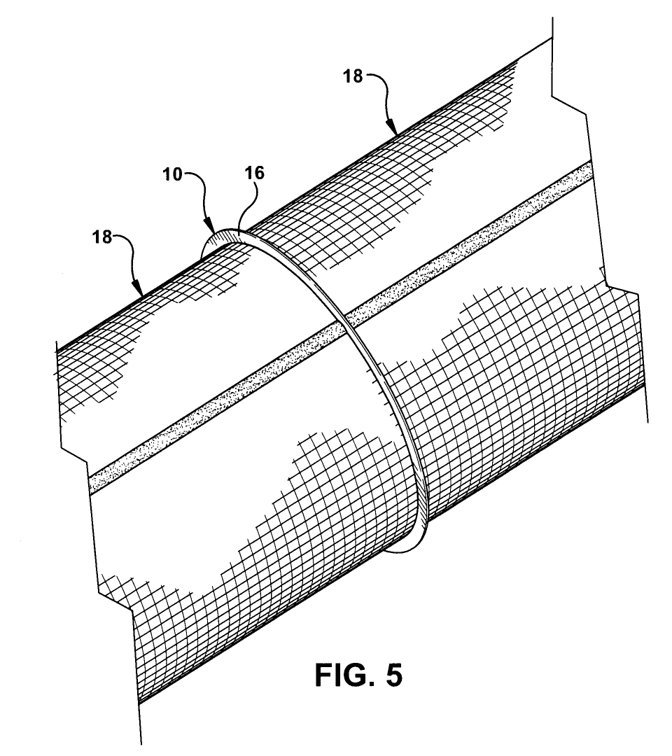

The screen joint 10 may be welded to the particle screen 18 to provide permanent connection thereto. When the screen joint 10 is assembled with a particle screen 18 on each side of the lip 16, as best seen in FIGS. 4 and 5, the lip 16 protrudes from the exterior surface 20. The protruding portion of the lip 16 may be welded or otherwise formed to create a seam 24 between the two connecting particle screen portions 18. The lip 16 may be designed to control the properties of the seam 24. For example, the width or thickness of the lip 16 may be increased or reduced to respectively increase or reduce the amount of material used in the seam 24.

It will be appreciated that the screen joint 10 may alternatively be configured to engage the exterior surface 20 of the particle screen 18. For example, as previously mentioned, the lip 16 may protrude from the inner surface 12 of the ring 11 to provide an adjoining surface interior to the screen joint 10. The particle screen 18 may then be inserted into the screen joint 10 such that the exterior surface 20 of the particle screen 18 engages the inner surface 12 of screen joint 10. The lip 16 may then be welded or formed to create an interior seam.

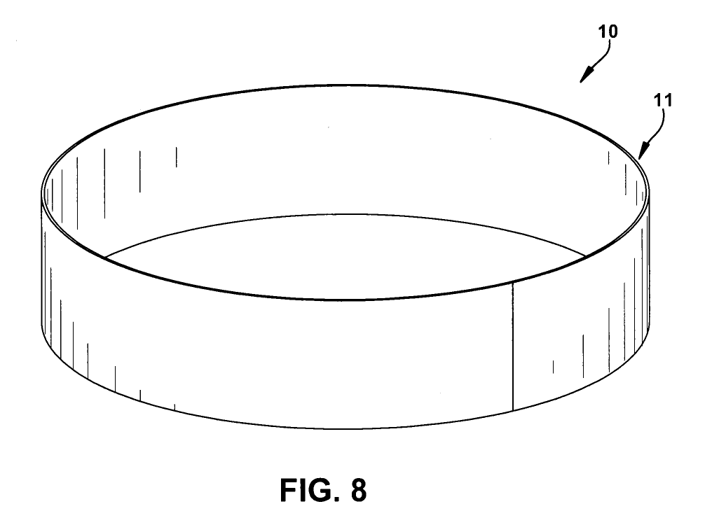

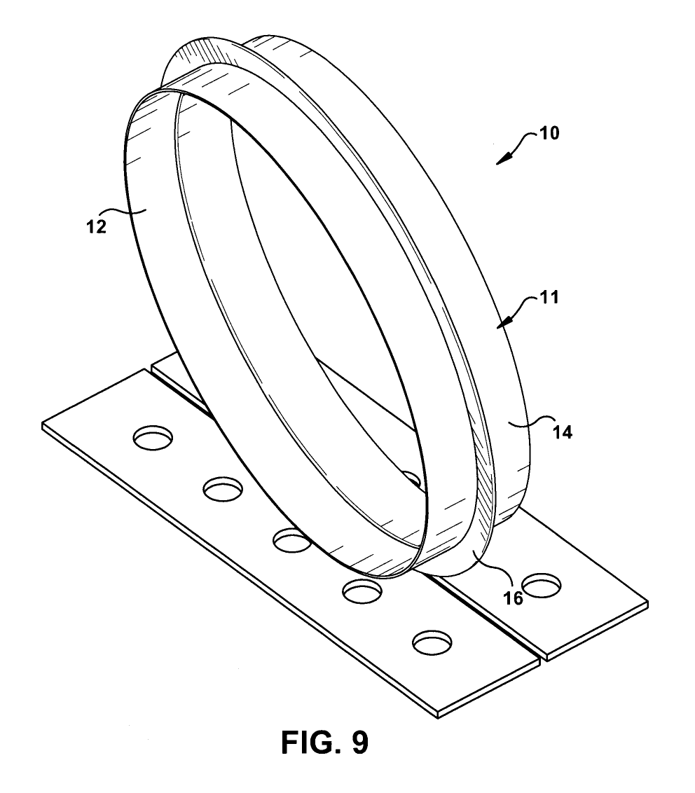

The screen joint 10 may be constructed by any means known in the art. In an embodiment, as illustrated in FIGS. 8 and 9, the screen joint 10 may be formed from raw sheet metal. The sheet metal may be cut to a specified length to achieve the desired diameter of the screen joint 10. The length of sheet metal may then be formed into a ring 11 having the desired shape. The ring 11 may be compressed using a tool to form the lip 16. Alternatively, the screen joint 10 may be formed through roll forming, through connecting a lip 16 to a ring member 11 as is known in the art, or by any other manner known in the art.

The invention has been described above and, obviously, modifications and alternations will occur to others upon a reading and understanding of this specification. The claims as follows are intended to include all modifications and alterations insofar as they come within the scope of the claims or the equivalent thereof.

1. A screen joint assembly comprising:
a joint comprising:
a ring;
a lip portion protruding from the ring;
a first particle screen connected to a first side of the joint; and
a second particle screen connected to a second side of the joint.

2. The screen joint assembly of claim 1, wherein the ring is circular.

3. The screen joint assembly of claim 1, wherein the lip portion protrudes from an exterior surface of the ring.

4. The screen joint assembly of claim 3, wherein the lip portion bisects the exterior surface of the ring

5. The screen joint assembly of claim 1, wherein the lip portion extends around the entire circumference of the ring.

6. The screen joint assembly of claim 1, wherein the first particle screen engages an exterior surface of the ring.

7. The screen joint assembly of claim 6, wherein the first particle screen engages an exterior surface of the ring.

8. The screen joint assembly of claim 1, wherein the first particle screen is positioned to abut the lip portion.

9. The screen joint assembly of claim 8, wherein the second particle screen is positioned to abut the lip portion.

10. The screen joint assembly of claim 1, wherein the lip portion forms a welded seam to interconnect the first particle screen and second particle screen.

11. The screen joint assembly of claim 1, wherein the joint is composed of steel or alloy steel.

12. A method of manufacturing a screen joint assembly comprising:
providing a joint comprising a ring and a lip portion protruding from the ring;
connecting a first particle screen to the ring;
connecting a second particle screen to the ring; and
welding the lip portion to form a weld seam interconnecting the first particle screen and the second particle screen.

13. The method of claim 11, wherein the lip portion protrudes from an exterior surface of the ring.

14. The method of claim 13, wherein the lip portion bisects the exterior surface of the ring.

15. The method of claim 11, wherein the ring is circular.

16. The method of claim 11, wherein the lip portion extends around the circumference of the ring.

17. The method of claim 11, wherein the lip portion is approximately perpendicular to the exterior surface of the ring.

18. The method of claim 11, wherein connecting a first particle screen to the ring comprises connecting an inner portion of the first particle screen to an exterior surface of the ring.

19. The method of claim 11, wherein connecting a first particle screen to the ring comprises abutting the first particle screen with the lip portion.

20. The screen joint assembly of claim 12, wherein the joint is composed of steel.
